(19) United States
(12) Patent Application Publication
(10) Pub. No.: US 2007/0255843 A1
(43) Pub. Date: Nov. 1, 2007

(54) Configuration of clients for multiple computer services

(76) Inventor: Alexander I. Zubev, Pazardjik (BG)

Correspondence Address: SAP/BLAKELY, 1279 OAKMEAD PARKWAY, SUNNYVALE, CA, 94085-4040, US

(21) Appl. No.: 11/413,362

(22) Filed: Apr. 28, 2006

(51) Int. Cl. G06F 15/16

(52) U.S. Cl. 709/230

(57) ABSTRACT

A method and apparatus for configuration of clients for multiple computer services. An embodiment of a method includes receiving multiple computer services, the computer services including a group of computer services, with the group of computer services having a logical address. A client is configured for the group of computer services, with the configuration of the client including resolving the logical address of the group of computer services to a physical address. The method includes receiving a request from the client for a first computer service in the group of computer services, where the request includes the logical address of the group and an identification of the requested computer service. A physical address for the requested computer service is resolved based on the request.

### TECHNICAL FIELD

Embodiments of the invention generally relate to the field of computer systems and, more particularly, to a method and apparatus for configuration of computer service clients for multiple computer services.

### BACKGROUND

In computer operations, computer services such as web services have become widely available because of the flexibility and ease of access in many different systems. In using web services in large enterprises, numerous web services may be provided to a client system to provide a wide variety of functions to the web service clients. The range of web services delivered by a developer to a client system may be very extensive in certain installations.

However, several properties need to be configured for web service clients in order for the clients to access certain web service operations. Such properties may include the physical address of each web service, username/password requirements, certificates to authenticate elements, and other related properties. In conventional operations, the logical addresses of the web services, as used by the web service clients, require resolution to physical addresses in memory, which may require the resolution of hundreds or thousands of addresses in certain types of installations.

It is generally impractical to ship or transport physical addresses for each of the web services as part of the delivered web service clients. Each installation generally will have unique characteristics, making a general solution for each installation impossible. Thus, in conventional operations, all web service clients that are delivered and that will be used to invoke various web services will need to be configured for each web service, which may be difficult and time-consuming task for the client.

### SUMMARY OF THE INVENTION

A method and apparatus for configuration of clients for multiple computer services.

In one aspect of the invention, a method includes receiving multiple computer services, the computer services including a group of computer services, with the group of computer services having a logical address. A client is configured for the group of computer services, with the configuration of the client including resolving the logical address of the group of computer services to a physical address. The method includes receiving a request from the client for a first computer service in the group of computer services, where the request includes the logical address of the group and an identification of the requested computer service. A physical address for the requested computer service is resolved based on the request.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an embodiment of computer service access;

FIG. 2 is an illustration of delivery of web services for a web services provider in an embodiment of the invention;

FIG. 3 is an illustration of the configuration of web service clients and usages in an embodiment of the invention;

FIG. 4 is a diagram illustrating an embodiment of a system architecture;

FIG. 5 is a block diagram illustrating an embodiment of an architecture including a web application server; and

FIG. 6 is an illustration of a computer system in an embodiment of the invention.

### DETAILED DESCRIPTION

Embodiments of the invention are generally directed to a method and apparatus for configuration of multiple computer service clients.

As used herein, “web service” means a software application assessable in a web environment. “Web service” includes the term as used by the World Wide Web. Consortium (W3C) in applicable standards, and is an example of a computer service. As used herein, “web service client” means a software application that consumes “web services”.

As used herein, a “logical address” or “virtual address” is a memory location that is addressed in terms of virtual memory. A logical address is mapped by hardware or software to a real (or physical) address. For example, a memory management unit may map virtual memory addresses to physical memory addresses.

As used here, a “physical address” is an actual or real address of a memory location. A physical address corresponds to a physical location.

As used herein, a “configuration” means the way in which the hardware or software of a computer is set up. “Configuration” includes, but is not limited to, the establishment of memory mapping requirements, including the manner in which virtual memory is mapped to physical memory.

In an embodiment of the invention, computer services, such as web services, are delivered to clients with metadata that describe their interfaces, policies and endpoint addresses (e.g. WSDL (web services description language), WS-Policy (web service policy)). In an embodiment of the invention, computer service clients are delivered to a client with metadata to allow configuration of the client for access to multiple web services together. In an embodiment, metadata provided with web services allows configuration of multiple web service clients simultaneously.

Web services and similar computer services provides a useful tool for clients, and web services developers may provide a client with a large number of web services to address the concerns of the clients. A web service can potentially be used in many different ways from many different systems. In certain operations, the number of web services may number in the thousands. In general, a web service provides a software system designed to support interoperable machine-to-machine interaction over a network. Web services conform to certain standards and thus provide a means of communication between applications on different platforms. Web services provide a mechanism for applications to communicate and interrelate in a platform independent fashion. Under an embodiment of the invention, a web service interface may be implemented in various different types of platforms, including but not limited to a J2EE (Java 2 Platform, Enterprise Edition) platform, an ABAP (Advanced Business Application Programming) platform of SAP AG, or another type of platform. A J2EE platform is described in the appropriate J2EE specification, including as provided in Java 2 Platform, Enterprise Edition version 1.4 (Nov. 24, 2003).

However, in conventional operations the delivery of a large number of web services results in a significant amount of effort that is required for configuration of the web service clients. In addition to any other configuration issues, each logical location for storage of a web service needs to be resolved to a physical address on the client system in order to configure the web service clients for operation. It is generally impractical for a developer to deliver web service clients that are configured for any particular web service location as each location is different with a unique set of characteristics.

In an embodiment of the invention, web services are provided to a client together with metadata to provide access to the web services without determining a physical address for each web service. In this embodiment, only certain of the logical addresses for the web services require resolution to physical addresses, with the metadata providing location information for the individual web services.

In an embodiment, a set of web services are provided to a client, with the web services being divisible into multiple groups. For example, a set of web services may be provided for payroll operations. Within the group of payroll operations web services may be a group of web service for calculation of salary and a second group of web services for determination of vacation hours. In an embodiment, a logical address for the first group and a logical address for the second group are provided, together with metadata to provide identification for the web services in each group. In order to configure the web service clients, the logical address for the first group of web services is resolved to a first physical address for the client, and a logical address for the second group of web services is resolved to a second physical address for the client. The physical addresses for the individual web services are not resolved manually, but instead are resolved automatically by the web service framework based on the metadata for the web services.

In operation, a call for a particular web service requires a call to its specific physical address. The web service client sends to the web service framework on the client system the logical address of the group where the desired service is located and an identification of the web service itself. Upon receipt of this call, the client system will find the physical address of the group using the provided logical address. The client system then will locate the required web service based on the metadata that has been provided to the client system. The metadata indicates where within a group a particular web service is located. Based on the physical address for the appropriate group and the location within the group indicated by the metadata based on the identification of the web service, the client system is able to provide the web service to a requestor.

In an embodiment of the invention, multiple security levels may be provided for configuration of web service clients. In an embodiment, a first level of security may be applied for access to metadata to identify web services. A second level of security may be applied for access to the web services themselves. In an example, the process for accessing identification metadata may not require the same level of security as the calling of web services. In an embodiment, a system sets up a first connection to allow the obtainment of metadata for establishment of web service client configuration, such connection being separate from any connection or connections for accessing web services. The system then sets up a second connection for access to the web services

In an embodiment of the invention, the web services may be accessed in the following manner:

Delivery time—A developer delivers a group of web services to a client provider. The web services may include a large number of web services, the web services being divided into multiple groups. Also delivered is metadata for the identification of web services within each of the groups.

Configuration time—The web service provider and the web service consumer configure the web service clients for access. In an embodiment, a separate configuration connection may be established for obtaining metadata, the metadata connection having a different security level than a connection for a client to a web service. In an embodiment, the logical address of each group of web services is resolved to a physical address, but the physical addresses of the individual web services are not manually resolved.

Runtime—At runtime, a web service may be called by identifying the web service, which may include identifying the logical address of the group for the web service and identifying a name for the web service. In this embodiment, the subgroup is accessed using the resolved physical address for the subgroup, with the appropriate web service in the subgroup being identified via the metadata. The web services are thus resolved automatically at runtime. In certain cases in which the names of the web services that are going to be consumed are known in advance, the automatic resolution of individual web services can also happen during configuration time.

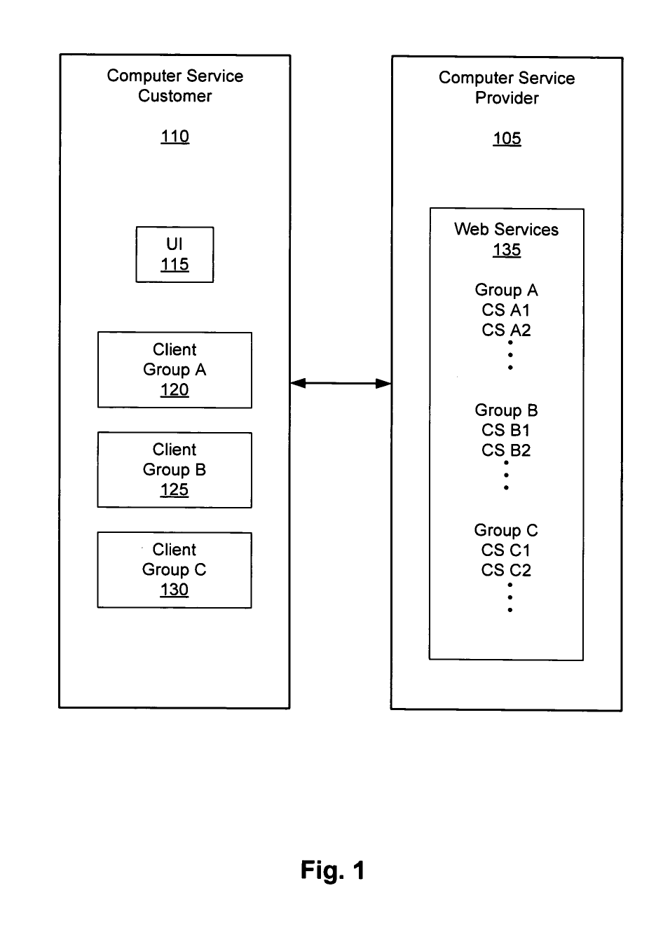

FIG. 1 is an illustration of an embodiment of computer service access. In this illustration, a computer service provider 105, who may receive computer services as a client of a computer service developer (not shown in this figure), provides computer services to a computer service customer 110. Computer services may include, but are not limited to, web services. The customer may include a user interface (UI) 115 or another non-UI application for use in accessing the computer services of the provider 105. The UI 115 may be any type of interface for the use of a customer, and may include an interface in which commands may be directly entered, including a graphical user interface (GUI) or a command line interface, or any other type of interface provided for a customer. The computer service customer 110 includes clients to invoke computer services. In one possible example, the customer 110 includes a one or more clients of particular groups of computer services, which are shown in the figure as a client of a group A 120, a client of a group B 125, and a client of a group C 130. For simplicity in explanation, each client is shown as being a client primarily of only one group of the computer services, but a client may require computer services in various groups and is not limited to any particular computer services or grouping of computer services.

The computer service provider 105 provides access to the computer services 135, which may be stored in various physical locations. In an embodiment, the computer services 135 may include a number of groups of computer services. The computer services 135 may be divided into groups in any manner, with one possible division being groups that relate to a certain subject matter. For example, if a set of computer services are provided for human resources operations, a group of such computer services may be related to salary calculation. In this illustration, the computer services are divided into group A, which includes computer service A1, computer service A2, and any number of other computer services; group B, which includes computer service B1, computer service B2, and any number of other computer services; and group C, which includes computer service C1, computer service C2, and any number of other computer services.

In a conventional operation, each of the services has a logical memory address and at a configuration time the logical address of each such computer service is resolved to a physical address. In embodiment of the invention, each group has a logical memory address that is resolved to a physical memory address, but the computer services within the groups are not resolved manually to physical addresses, thereby simplifying the configuration process. In such embodiment, each client of the customer can access the computer services as needed by providing the logical address of the group and an identification of the required computer service. Based on such information, the client system can locate the needed computer service within a subgroup and provide such service to the relevant client of the customer.

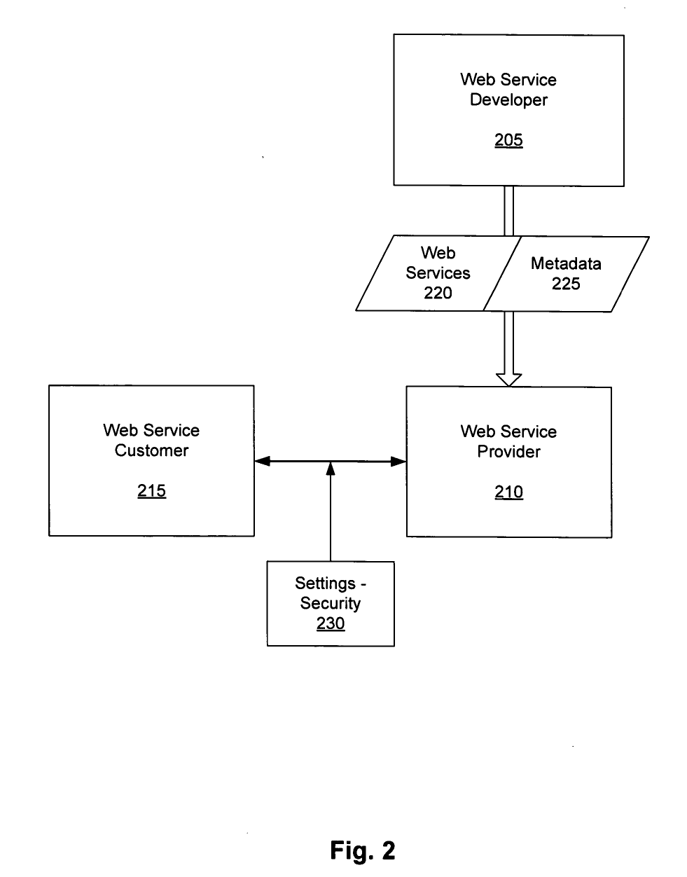

FIG. 2 is an illustration of delivery of web services for a web services provider in an embodiment of the invention. In FIG. 2, a web service developer 205 provides web services to a web service provider 210, which are to be used to provide web services to a customer 215. In an embodiment of the invention, in addition to the web services 220 the web service developer provides metadata regarding such web services, the metadata 225 describing the location of web services in each of a number of groups of the web services. In an embodiment of the invention, the metadata may be used in the establishment of settings 230, including security settings, at configuration time. In this embodiment, the metadata is used to reduce the amount of time and effort required to resolve the web services 220 for the configuration of web service clients.

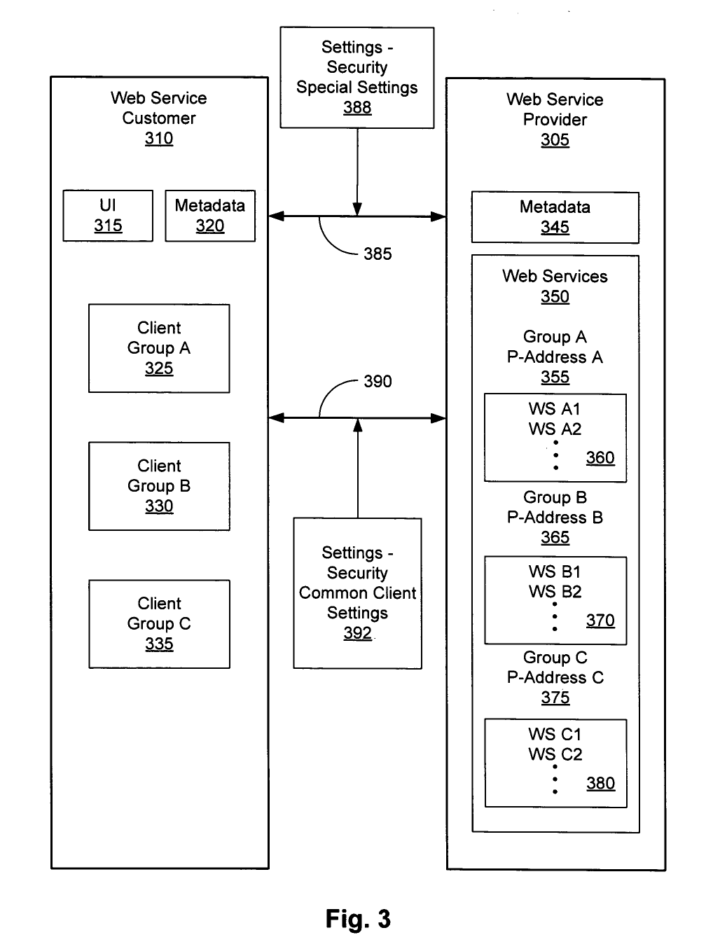

FIG. 3 is an illustration of the configuration of web service clients and usages in an embodiment of the invention. In this illustration, a web service provider 305 is linked to a web service customer 310 to provide web services to the web service customer 310. In an embodiment of the invention, the customer includes an interface UI 315 for access to web services, and further includes metadata regarding the web services. In one example, the web service customer includes multiple web service clients, including a first client primarily interested in a group A of web services 325, a second client primarily interested in a group B of web services 330, and a third client primarily interested in a group C of web services 335.

In an embodiment of the invention, the web service provider 305 provides access to the group of web services 350. The configuration of the web service client 350 includes resolving a logical address for subgroups of the web services, but not providing physical addresses for individual web services. In this illustration, the web services include a subgroup A that is resolved to a physical address A 350. The web services for the subgroup are shown as web services A1, A2, other others 360, such web services not being resolved to physical addresses in configuration. Further, the web services 350 includes a subgroup B that is resolved to a physical address B 355, which includes web services B1, B2, and others 360, and a subgroup C that is resolved to a physical address C 375, which includes web services C1, C2, and others 380. The provider 305 further includes a set of metadata 345 that includes data to enable automatic resolution of the addresses of the web services based on the logical address of the group, which has been resolved to a physical address, and on an identification of the web service.

In one example, if a client, such as the client subgroup A 325, requires web service A2 in the subgroup A of web services, the customer 310 may request access to the web service, possibly via the user interface 315, using the metadata 320 of the customer 310 to obtain the required logical address for the relevant subgroup and to obtain the required identification of web service A2. In an embodiment of the invention, the configuration of the connections between the web service provider 305 and the web service customer 310 includes providing certain settings, including the security for the connection. For example, a setting may include the establishment of an authority or security level that is required for access to a connection. In a particular embodiment, the configuration of the connections between the web service provider 305 and the web service customer 310 includes the generation of a first type of connection 385 for obtaining information regarding the access of web services and a second type of connection 390 to provide the access to the web services. In an embodiment, the web service customer 310 uses certain metadata 320 to obtain other metadata 345 needed to identify and access a web service, the metadata being obtained via the first type of connection 385. The web service customer 310 then uses the second type of connection 390 to gain access to the required web service. In an embodiment, the first connection 385 may include certain settings 388, including a first security level for accessing the metadata regarding web services. The second connection 390 may include certain settings 392, including a second security level for accessing the web services. For example, the first security setting may require a lower authority level since this connection is only used for accessing the metadata to identify a web service, while the second security setting may require a higher authority level since this connection is used for actually accessing the web service.

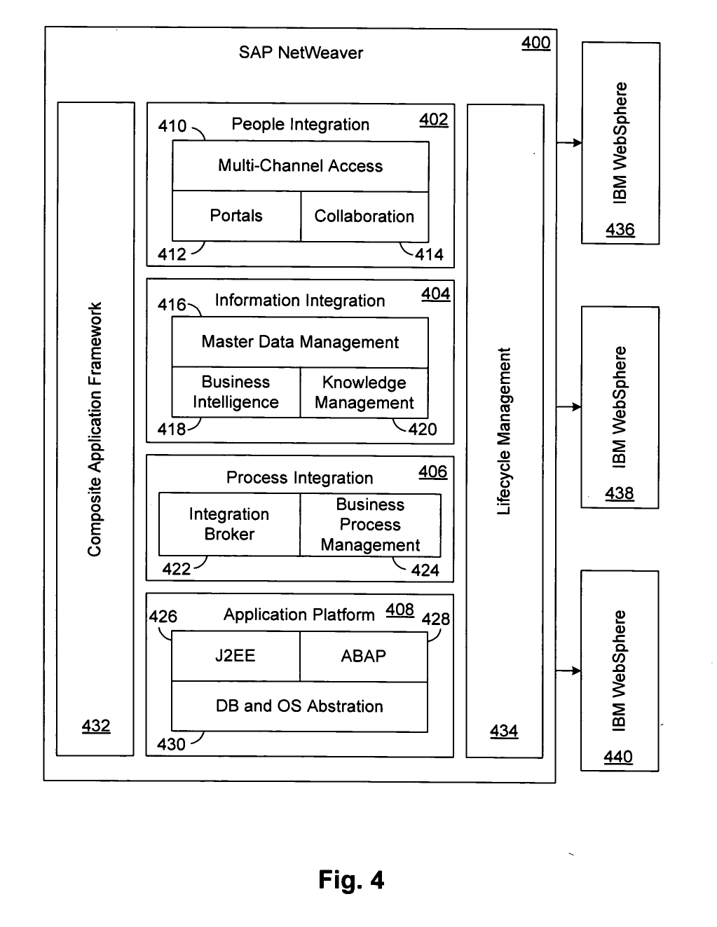

FIG. 4 is a diagram illustrating an embodiment of a system architecture. In one embodiment, the diagram illustrates core components of the SAP NetWeaver architecture 400. The system architecture 400 comprises various SAP platforms that are merged together to provide the integration of people, information, and processes in one solution. The architecture 400 includes people integration 402, information integration 404, process integration 406, and an application platform 408.

People integration 402 is performed using a portal solution 412 and a platform to work in collaboration 414. Users are provided a multi-channel access 410 to ensure mobility. Examples of the portal solution 412 include SAP Enterprise Portal, SAP Mobile Engine, and Collaboration Package for SAP Enterprise Portal. Information integration 404 refers to the conversion of information into knowledge. Information integration 404 provides efficient business intelligence 418 and knowledge management 420 using, for example, SAP products such as Business Information Warehouse (BW) and Knowledge Management (KM). Further, consolidation of master data management beyond system boundaries is performed using SAP's Master Data Management (MDM) 416. Process integration 406 refers to optimized process management using integration broker or SAP exchange infrastructure 422 and business process management 424 techniques. Examples of products to perform process integration 406 include Exchange Infrastructure (XI) and Business Process Management (BPM).

An application platform 408 may include SAP's Web Application Server (web AS), which is the basis for SAP applications. The web AS, which may be independent of the database and operating system 430, includes a J2EE engine 426 in combination with the proprietary SAP ABAP (Advanced Business Application Programming) engine or instance 428 to further enhance the application platform 408. In one embodiment, the web AS is used to provide web services to a client. The web AS may include a group of web services, the groups possibly including one or more subgroups. A logical address of subgroup may be resolved to a physical address, with the web services in the subgroup being unresolved in configuration. In an embodiment, the web AS can provide a web service to a client via a call that provides the logical address of the relevant group of web services and identifies the web service in the group.

The architecture 400 further includes a composite application framework 432 to provide various open interfaces (APIs—application program interface) and a lifecycle management 434, which is an extension of a previously existing transport management system (TMS). As illustrated, the architecture 400 further provides communication with Microsoft.NET 436, International Business Machine (IBM) WebSphere 438, and other such systems 440.

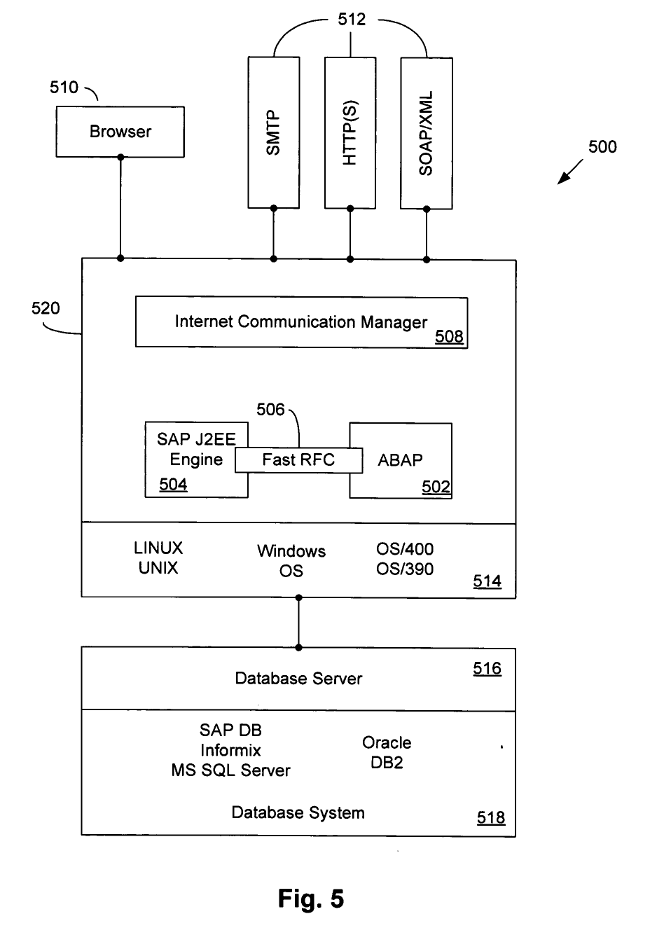

FIG. 5 is a block diagram illustrating an embodiment of an architecture including a web application server. In this illustration, an architecture 500 serves as an application platform (which may be, for example, the application platform 408 of provided in FIG. 4) for SAP NetWeaver and other SAP products. The architecture 500 includes a web AS 520 having, for example, an ABAP program engine 502, which provides the ABAP development and runtime environment, with the dependability, scalability, and inter-process independence of operating systems 514 and database systems 518. The operating system 514 may include LINUX, UNIX, Windows, OS/390, OS/400, and other such operating systems. The database system 518 may include SAP database (SAP DB), Informix, Oracle, DB2, and other such database systems. The database system 518 is based on a database server 516, such as Microsoft Sequential Query Language (MS SQL) server.

The web AS 520 with ABAP engine 502 further includes a J2EE program engine 504. The J2EE program engine 504 may support one or more program instances. In this example, the J2EE engine 504 may be in communication with the ABAP engine 502 via a fast remote function call (RFC) connection 506. The ABAP engine 502 and the J2EE engine 504 are further in communication with an Internet communication manager (ICM) 508. The ICM 508 is provided for handling and distributing queries to various individual components of the architecture 500. The architecture 500 further supports a browser 510, such as Microsoft Internet Explorer, Netscape Navigator, and other modified variations of mobile end devices, such as personal digital assistants (PDAs), pocket computers, smart cell phones, other hybrid devices, and the like. The web application server 520 also supports various protocols and standards 512, such as HyperText Markup Language (HTML), eXtensible Markup Language (XML), Wireless Markup Language (WML), Hypertext Transfer Protocol (HTTP) and Hypertext Transfer Protocol, Secure (HTTP(S)), Simple Mail Transfer Protocol (SMTP), Web Distributed Authority and Versioning (WebDAV), Simple Object Access Protocol (SOAP), Single Sign-On (SSO), Secure Sockets Layer (SSL), X.509, Unicode, and the like. In one embodiment, the Web AS is used to provide web services to a client. The Web AS may include a set of web services, the set possibly including one or more groups. A logical address of group may be resolved to a physical address, with the web services in the group being unresolved in configuration. In an embodiment, the Web AS can provide a web service to a client via a call that provides the logical address of the subgroup and identifies the web service in the group.

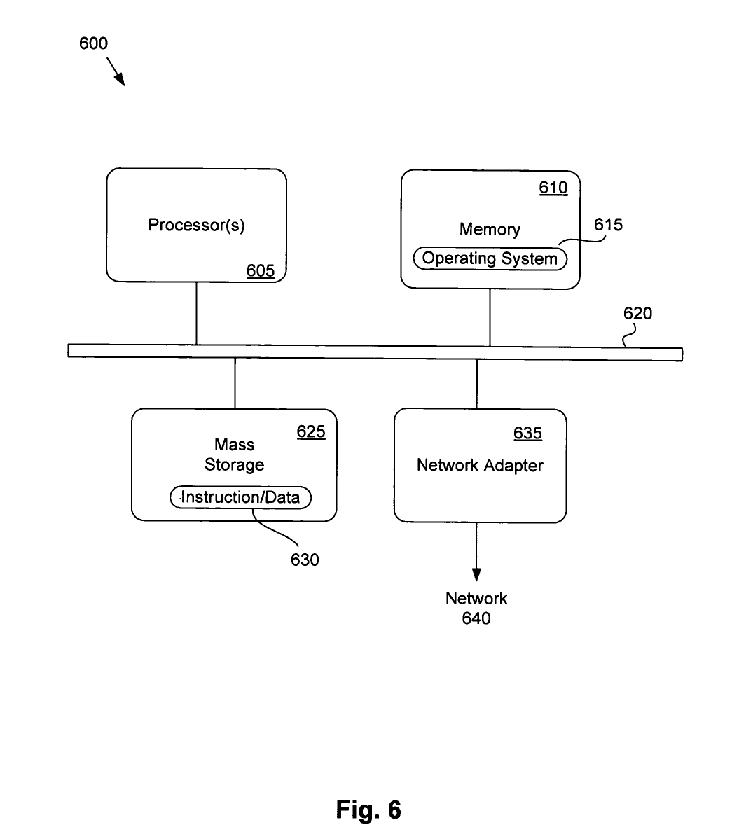

FIG. 6 is an illustration of a computer system in an embodiment of the invention. As illustrated, a computing system 600 can execute program code stored by an article of manufacture. The computing system illustrated in FIG. 6 is only one of various possible computing system architectures, and is a simplified illustration that does include many well-known elements. A computer system 600 includes one or more processors 605 and memory 610 coupled to a bus system 620. The bus system 620 is an abstraction that represents any one or more separate physical buses, point-to-point connections, or both connected by appropriate bridges, adapters, or controllers. The bus system 620 may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements thereto)

As illustrated in FIG. 6, the processors 605 are central processing units (CPUs) of the computer system 600 and control the overall operation of the computer system 600. The processors 605 execute software stored in memory 610. A processor 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 610 is or includes the main memory of the computer system 600. Memory 610 represents any form of random access memory (RAM), read-only memory (ROM), flash memory, or the like, or a combination of such devices. Memory 610 stores, among other things, the operating system 615 of the computer system 600.

Also connected to the processors 605 through the bus system 620 are one or more internal mass storage devices 625 and a network adapter 635. Internal mass storage devices 625 may be or may include any conventional medium for storing large volumes of instructions and data 630 in a non-volatile manner, such as one or more magnetic or optical based disks. The network adapter 635 provides the computer system 600 with the ability to communicate with remote devices, over a network 650 and may be, for example, an Ethernet adapter.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A method comprising:
receiving a plurality of computer services, the plurality of computer services including a group of computer services, the group of computer services having a logical address;
configuring a client for the group of computer services, the configuration of the client including resolving the logical address of the group of computer services to a physical address;
receiving a request from the client for a first computer service in the group of computer services, the request including the logical address of the group and an identification of the requested computer service; and
resolving a physical address for the requested computer service based on the request.

2. The method of claim 1, wherein group of computer services includes a plurality of web services.

3. The method of claim 1, further comprising providing metadata for the client regarding the plurality of computer services.

4. The method of claim 3, wherein the physical address of the requested computer service is located using metadata regarding the plurality of computer services.

5. The method of claim 3, further comprising generating a first type of connection for the transfer of the metadata regarding the plurality of computer services.

6. The method of claim 5, further comprising generating a second type of connection for access to the group of computer services.

7. The method of claim 6, wherein generating the first type of connection comprises establishing a first security access level for the first type of connection.

8. The method of claim 7, wherein generating the second type of connection comprises establishing a second security access level for the second type of connection, the second security access level being a higher security level than the first security level.

9. A server comprising:
a bus;
a processor coupled with the bus, the processor to process requests for services;
a memory coupled with the bus to contain a plurality of web services, the plurality of web services including a group of web services, and to contain a set of metadata regarding the plurality of web services; and
a link with a web service customer, the web service customer including a client for the group of web services;
wherein the processor is to provide a first web service to the client in response to a request, the request including a logical address for the group of web services and an identification of the first web service.

10. The server of claim 9, wherein the processor is to provide the metadata to the client to configure the client for the group of web services.

11. The server of claim 9, wherein the link includes a first connection for transfer of the metadata and a second connection for access to the plurality of web services.

12. The server of claim 11, where the first connection has a first security level and the second connection has a second security level.

13. A system comprising:
a web service provider, the web service provider to include a plurality of web services and a set of metadata regarding the plurality of web services, the plurality of web services including a group of web services; and
a web service customer to communicate with the web service provider, the web service customer to include a client for the group of web services;
wherein the web service provider is to provide a provide a web service in the group to the client in response to a request, the request providing a logical address for the group of web services and identifying the web service.

14. The system of claim 13, wherein the client is configured at configuration time by resolving a physical address for the group of web services.

15. The system of claim 14, wherein the client is further configured using metadata from the web service provided to identify the web services in the group.

16. The system of claim 15, wherein the configuration of the client at configuration time does not include the resolution of the physical addresses of the web services in the group.

17. A machine-readable medium having stored thereon data representing sequences of instructions that, when executed by a machine, cause the machine to perform operations comprising:
receiving a plurality of web services, the plurality of web services including a group of web services, the group of web services having a logical address; and
configuring a client for the group of computer services, the configuration of the client including resolving the logical address of the group of web services to a physical address and providing metadata to identify the web services of the group.

18. The medium of claim 17, further comprising instructions that cause the machine to perform operations comprising:
receiving a request from the client for a web service in the group of web services; and
locating the web service based on the logical address of the group and an identification of the requested web service.

19. The medium of claim 18, wherein locating the web service comprises dynamically resolving a physical address for the requested web service.

20. The medium of claim 17, further comprising instructions that cause the machine to perform operations comprising:
establishing a first type of connection for the provision of the metadata regarding the plurality of web services; and
establishing a second type of connection for access to the group of web services.
